(19) United States
(12) Patent Application Publication
(10) Pub. No.: US 2010/0041831 A1
(43) Pub. Date: Feb. 18, 2010

(54) IMPACT MODIFIED POLYCARBONATE-POLYLACTIC ACID COMPOSITION

(75) Inventors: JAMES Y.J. CHUNG, Wexford, PA (US); James P. Mason, Carnegie, PA (US)

Correspondence Address: BAYER MATERIAL SCIENCE LLC, 100 BAYER ROAD, PITTSBURGH, PA, 15205, US

(73) Assignee: BAYER MATERIALSCIENCE LLC, Pittsburgh, PA (US)

(21) Appl. No.: 12/192,476

(22) Filed: Aug. 15, 2008

(51) Int. Cl. C08G 63/08

(52) U.S. Cl. 525/186

(57) ABSTRACT

The present invention relates to a thermoplastic molding composition containing an aromatic polycarbonate, a polylactic acid and an impact modifying amount of a non-functionalized ethylene/(meth)acrylate copolymer. The inventive composition is characterized by its higher impact resistance, flexural and tensile properties than those of corresponding compositions where the copolymer is functionalized.

### FIELD OF THE INVENTION

The present invention relates, in general, to a thermoplastic molding composition, and more particularly, to a composition containing a polycarbonate, a polylactic acid and an impact modifying amount of a non-functionalized ethylene/(meth)acrylate copolymer.

### BACKGROUND OF THE INVENTION

Polycarbonate resins and thermoplastic molding compositions containing polycarbonate are known and been used widely for many years. Their excellent physical properties make polycarbonate resins suitable for a making a variety of molded and shaped articles. Polycarbonate compositions that include blends with other resins and/or functional additives have been disclosed in a large number of publications, including patent literature.

Polylactic acid (also referred to as polylactide or “PLA”) is known and its use as a component in plastic compositions has been reported in, among others, U.S. Pat. No. 5,272,221, issued to Kitao, et al. in which polylactic acid is disclosed as a component in a composition containing nylon.

Tokushige, et al., in U.S. Pat. No. 5,726,220, disclose biodegradable compositions said to exhibit excellent mold release properties and improved elongation at break and impact strength without affecting the transparency and containing polylactic acid and ethylene vinyl acetate copolymer.

U.S. Pat. No. 6,262,184, issued to Kanamori, et al., describes a biodegradable composition comprising polylactic acid and aliphatic polyester carbonate, having practically adequate heat-resistance temperature, moldability, thermal stability, solvent resistance and high mechanical strength.

Tan, et al., in U.S. Pat. No. 6,710,135, teach a composition containing polylactic acid and a specified polyalkylene carbonate. The composition is said to he biodegradable, transparent, flexible and possessing gas barrier properties and suitable for molding articles that exhibit high biodegradability in natural environment.

Also known are additives which improve the impact performance of thermoplastic polycarbonate compositions U.S. Published Patent Application No. 2003/0216508, in the name of Lee, describes the impact performance modifying efficacy of ethylene/acrylate copolymer in the context of a composition that contains polycarbonate and ABS.

Kobayashi, et al., in U.S. Pat. No. 5,043,200, provide a composition containing a styrene resin, thermoplastic polyester resin, aromatic polycarbonate resin and ethylene-ethyl acrylate copolymer resin. This composition is said to exhibit excellent impact resistance.

Japanese patent application 2006-028299, in the name of Hayata et al., discloses the addition of 5 parts of an epoxy-modified ethylene-methacrylate copolymer to 70 parts of polycarbonate and 30 parts of polylactic acid to increase the Izod impact strength from 5 to 10 kJ/m². However, Hayata et al. provide no teaching of the criticality of the amount of polylactide on impact properties.

A need continues to exist in the art for thermoplastic molding compositions having improved impact, flexural and tensile properties for a variety of demanding applications.

### SUMMARY OF THE INVENTION

Accordingly, the present invention provides a thermoplastic molding composition containing an aromatic polycarbonate, a polylactic acid and an impact modifying amount of a non-functionalized ethylene/(meth)acrylate copolymer. The inventive composition is characterized by its higher notched Izod- and dart-impact strengths; additionally, the flexural and tensile properties of the composition of the present invention are better than those of corresponding compositions where the copolymer is functionalized with carbon monoxide or epoxy groups.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a thermoplastic molding composition made from an aromatic polycarbonate, a polylactic acid and an impact modifying amount of a non-functionalize ethylene(meth)acrylate copolymer.

The term polycarbonate as used in the context of the present invention refers to homopolycarbonates and copolycarbonates (including polyestercarbonates).

Polycarbonates are known and their structure and methods of preparation have been disclosed, for example, in U.S. Pat. Nos. 3,030,331; 3,169,121; 3,395,119; 3,729,447; 4,255,556; 4,260,731; 4,369,303, 4,714,746 and 6,306,507; all of which are incorporated by reference herein. The polycarbonates preferably have a weight average molecular weight of 10,000 to 200,000, more preferably 20,000 to 80,000 and their melt flow rate, per ASTM D-1238 at 300° C., is 1 to 65 g/10 min., preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2).

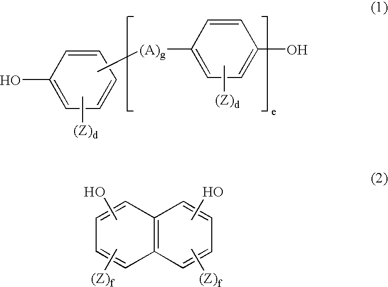

wherein,
A denotes an alkylene group with 1 to 8 carbon atoms, an alkylidene group with 2 to 8 carbon atoms, a cycloalkylene group with 5 to 15 carbon atoms, a

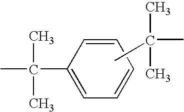

cycloalkylidene group with 5 to 15 carbon atoms, a single bond, a carbonyl group, an oxygen atom, a sulfur atom, —SO— or —SO₂ or a radical conforming to
e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,105,004; 5,126,428; 5,109,076; 5,104,723; 5,086,157; 3,028,356; 2,999,835; 3,148,172; 2,991,273; 3,271,367; and 2,999,846, all of which are incorporated herein by reference.

Further examples of suitable bisphenols are 2,2-bis-(4-hydroxy-phenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone dihydroxy-benzophenone, 2,4-bis-(3,5-(dimethyl-4-hydroxyphenyl)-cyclohexane, α,α′-bis-(3,5-dimethyl-4-hydroxyphenyl)-p-diisopropyl-benzene,1,1-bis-(4-hydroxy-phenyl)-3,3,5-trimethylcyclohexane, 4,4′-dihydroxydiphenyl, and 4,4′-sulfonyl diphenol. Examples of particularly preferred bisphenols are 2,2-bis-(4-hydroxyphenyl)-propane, 2,2-bis-(3,5-dimethyl-4-hydroxyphenyl)-propane; 1,1-bis-(4-hydroxyphenyl)-cyclohexane and 4,4′-dihydroxydiphenyl. The most preferred bisphenol is 2,2-bis-(4-hydroxyphenyl)-propane (bisphenol A).

The polycarbonates of the invention may entail in their structure units derived from one or more aromatic dihydroxy compounds.

The polycarbonates of the invention may also be branched by condensing therein small quantities, e.g., 0.05 to 2.0 mol % (relative to the bisphenols) of polyhydroxyl compounds as branching agents. Such branching agents suitable in the context of polycarbonate are known and include the agents disclosed in U.S. Pat. Nos. 4,185,009; 5,367,044; 6,528,612; and 6,613,869 which are incorporated herein by reference, preferred branching agents include isatin biscresol and 1,1,1-tris-(4-hydroxyphenyl)ethane (THPE).

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropyl-idine)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 all of which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used.

Suitable polycarbonate resins are available in commerce, for instance, under the MAKROLON trademark from Bayer MaterialScience LLC of Pittsburgh, Pa.

The polylactic acid polymer suitable in the context of this invention refers to a melt processable polymer based on D and/or L lactic acid preferably having molecular weight lower than 1,000,000, more preferably lower than 150,000 and most preferably from 50,000 to 110,000, its melt flow rate is preferably 1 to 200, more preferably 2 to 50, most preferably 3 to about 20 g/10 minutes, as determined according to ASTM D1238-E (210° C./2.16 kg). Polylactic acid characteristically has a glass transition temperature around 59° C. and a melting point of 178° C.

The ethylene/(meth)acrylate copolymer suitable in the present invention is not functionalized. These are derived from the copolymerization of ethylene and one or more C₁ to C₈ alkylesters of acrylic acid or methacrylic acid. Preferably, the alkyl(meth)acrylate is n-butyl acrylic acid ester or ethyl acrylic acid ester, methyl acrylic acid ester; methyl acrylate being the most preferred.

The melt flow rate of the suitable copolymer is preferably 0.1 to 15 g/10 min. at 190° C./2.16 kg (per ISO 1133/ASTM D1238), more preferably 0.2 to 2 g/10 min., and its ethylene content is preferably 90 to 60%, more preferably 80 to 70% by weight.

The inventive composition contains (i) polycarbonate preferably in an amount of 40 to 90 wt. %, more preferably 50-90 wt. %, (ii) polylactic acid preferably in an amount of about 5 to 55 wt. %, more preferably 5 to 50 wt. % and (iii) non-functionalized ethylene/(meth)acrylate copolymer preferably in an amount of 2 to 12 wt. %, more preferably 3 to 10 wt. %, the wt. %, all occurrences being relative to the total weight of polycarbonate. polylactic acid and ethylene/(meth)acrylate copolymer. The alkyl group of acrylate is selected from methyl, ethyl, butyl andl hexyl groups. The preferred alkyl group is methyl and/or ethyl, more preferably methyl.

The compositions may be prepared by mixing the components in any order at an elevated temperature and under high shear by any conventional method.

Functional additives known for their efficacy in the context of polycarbonate molding compositions may be included in the inventive composition. These additives may be used in amounts sufficient to manifest their utility and may include pigments, dyes, fillers, ultraviolet light stabilizers, antioxidants, melt stabilizers, processing aids, reinforcing agents, anti-slip agents, plasticizers, drip suppressants and flame retardants. These are well known and commercially available.

### EXAMPLES

The present invention is further illustrated, but is not to be limited, by the following examples. All quantities given in “parts” and “percents” are understood to be by weight, unless otherwise indicated. In preparing the exemplified compositions, the following components were used:

| | |
|---|---|
| POLYCARBONATE | homopolycarbonate based on bisphenol A, having melt |
| | volume rate (“MVR”) at 300° C./1.2 kg of 11, available from |
| | Bayer MaterialScience as MAKROLON 2608; |
| POLYLACTIC ACID | having a melt index of 5-7 g/10 min at 210° C./2.16 kg, |
| | tensile modulus of 3.5 GPa, tensile elongation of 6% at |
| | break, and notched Izod impact strength of 0.24 ft-lb/in per |
| | enclosed data sheet available as from Nature Works PLA |
| | 2002D; |
| IMPACT MODIFIER A | a copolymer of ethylene/methyl acrylate with 25% methyl |
| | acrylate with a melt flow rate of 0.4 g/10 min at |
| | 190° C./2.16 Kg and melting point of 90° C. available from |
| | E. I. du Pont de Nemours & Co. as ELVALOY 1125AC; |
| IMPACT MODIFIER B | a copolymer of ethylene/n-butyl acrylate/carbon monoxide |
| | terpolymer, with a melt flow rate of 12 g/10 min at |
| | 190° C./2.16 kg and melting point of 59° C. available from E. I. du |
| | Pont de Nemours & Co. as ELVALOY HP4051; and |
| IMPACT MODIFIER C | a copolymer of ethylene/n-butyl acrylate/glycidyl |
| | methacrylate with a melt flow rate of 12 g/10 min at |
| | 190° C./2.16 kg and melting point of 72° C. available from E. I. du |
| | Pont de Nemours & Co. as ELVALOY PTW. |

The exemplified compositions were prepared by extrusion compounding using a twin screw extruder at a melt temperature of about 250° C. and test specimens at ⅛″ thickness were produced by injection molding at around 250° C.

Tensile properties, flexural properties, notched Izod impact strength were determined according to ASTM D-638, D-790 and -256, respectively. Melt flow rate was determined at 265° C./5 kg, and dart impact strength was determined at 15 mph, 3 in. stage and 0.5 in. dart.

The properties of the impact-modified polycarbonate blends containing polylactic acid at 10 wt. % (Examples 1, C-2 and C-3) and 20 wt. % (Examples 4, C-5 and C-6) are shown in Tables I and II, respectively.

TABLE I

| | Ex. 1 | Ex. C-2 | Ex. C-3 |
|---|---|---|---|
| Component | | | |
| POLYCARBONATE, wt % | 82 | 82 | 82 |
| POLYLACTIC ACID, wt % | 10 | 10 | 10 |
| IMPACT MODIFIER A, wt % | 8 | — | — |
| IMPACT MODIFIER B, wt % | — | 8 | — |
| IMPACT MODIFIER C, wt % | — | — | 8 |
| Physical properties | | | |
| MVR, cm³/10 min. | 23 | 23 | 17 |
| Notched Izod @ 23° C. (ft-lb/in) | 18 | 14 | 16 |
| Dart impact strength (ft-lb) @ 23° C. | 38.3 | 37.8 | 37.9 |
| Flexural modulus, MPa | 2213 | 2168 | 2134 |
| Flexural Strength (MPa) at maximum stress | 91 | 89 | 85 |
| Tensile Modulus (MPa) | 2133 | 2106 | 2084 |
| Tensile Elongation (%) at break | 85 | 12 | 18 |
| Tensile Strength (MPa) at ultimate | 56 | 55 | 54 |

By reference to Tables I and II, one can appreciate the advantageous properties of the inventive compositions containing the non-functionalize impact modifier in comparison to those compositions that are identical in all respects except for the functionalized impact modifiers.

TABLE II

| | Ex. 4 | Ex. C-5 | Ex. C-6 |
|---|---|---|---|
| Component | | | |
| POLYCARBONATE, wt % | 72 | 72 | 72 |
| POLYLACTIC ACID, wt % | 20 | 20 | 20 |
| IMPACT MODIFIER A, wt % | 8 | — | — |
| IMPACT MODIFIER B, wt % | — | 8 | — |
| IMPACT MODIFIER C, wt % | — | — | 8 |
| Physical properties | | | |
| MVR, cm³/10 min. | 28 | 31 | 22 |
| Notched Izod @ 23° C. (ft-lb/in) | 18 | 8 | 16 |
| Dart impact strength (ft-lb) @ 23° C. | 38 | 36 | 35 |
| Flexural modulus (MPa) | 2389 | 2328 | 2226 |
| Flexural Strength (MPa) at maximum stress | 94 | 92 | 85 |
| Tensile modulus (MPa) | 2304 | 2166 | 2175 |
| Tensile elongation (%) at break | 146 | 106 | 98 |
| Tensile strength (MPa) at ultimate | 64 | 57 | 55 |

Table III illustrates the properties versus the polylactic acid content of impact modified polycarbonate/polylactic acid blends containing Impact Modifier A at 4 wt. %. As can be appreciated by a review of Table III, increasing the polylactic acid content to 60 wt. % reduces the notched Izod impact strength to 2.1 ft/lb/in.

TABLE III

| | Ex. 7 | Ex. 8 | Ex. 9 | Ex. C-10 | Ex. C-11 |
|---|---|---|---|---|---|
| Component | | | | | |
| POLYCARBONATE, wt % | 86 | 76 | 56 | 36 | 16 |
| POLYLACTIC ACID, wt % | 10 | 20 | 40 | 60 | 80 |
| IMPACT MODIFIER A, wt % | 4 | 4 | 4 | 4 | 4 |
| Physical properties | | | | | |
| MVR, (cm³/10 min.) | 19.6 | 21.5 | 47.3 | 67.6 | 89.9 |
| Notched Izod @23° C. (ft-lb/in) | 15.7 | 13.5 | 11 | 2.1 | 0.9 |
| Dart impact strength (ft-lb) @23° C. | 38 | 41 | 38 | 41 | 38 |
| Flexural modulus (MPa) | 2374 | 2446 | 2675 | 2914 | 3035 |
| Flexural Strength (MPa) at maximum stress | 98.8 | 102.3 | 104.3 | 104.4 | 103.8 |
| Tensile Modulus (MPa) | 2302 | 2459 | 2669 | 2914 | 3035 |
| Tensile Elongation (%) at break | 122 | 122 | 135 | 109 | 15 |
| Tensile Strength (MPa) at ultimate | 65 | 60 | 61 | 64 | 63 |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A thermoplastic molding composition comprising an aromatic polycarbonate, a polylactic acid and an impact modifying amount of a non-functionalized ethylene/(meth)acrylate copolymer.

2. The thermoplastic molding composition according to claim 1, wherein the polycarbonate is present in amount of about 40 to about 90 percent relative to the weight of the composition.

3. The thermoplastic molding composition according to claim 1, wherein the polycarbonate is present in amount of about 50 to about 90 percent relative to the weight of the composition.

4. The composition according to claim 1, wherein the polylactic acid is present in an amount of about 5 to about 55 percent relative to the weight of the composition.

5. The composition according to claim 1 wherein the polylactic acid is present in an amount of about 5 to about 50 percent relative to the weight of the composition.

6. The composition according to claim 1 wherein the polylactic acid is present in an amount of about 5 to about 40 percent relative to the weight of the composition.

7. The composition according to claim 1 wherein the non-functionalized ethylene/(meth)acrylate copolymer is present in an amount of about 2 to about 12 percent relative to the weight of the composition.

8. The composition according to claim 1 wherein the non-functionalized ethylene/(meth)acrylate copolymer is present in an amount of about 3 to about 10 percent relative to the weight of the composition.

9. The composition according to claim 1 wherein the non-functionalized ethylene/(meth)acrylate copolymer is present in an amount of about 4 to about 8 percent relative to the weight of the composition.

10. The composition according to claim 1 wherein the non-functionalized ethylene/(meth)acrylate copolymer is selected from the group consisting of ethylene/n-butylacrylate copolymer, ethylene/hexyl acrylate copolymer, ethylene/butyl acrylate copolymer, ethylene/ethyl acrylate copolymer and ethylene/methyl acrylate copolymer.

11. The composition according to claim 1 wherein the non-functionalized ethylene/(meth)acrylate copolymer is ethylene/methyl acrylate copolymer.

12. The composition according to claim 1 wherein the functionalized copolymer contains epoxy and/or carbon monoxide groups.
